(19) United States
(12) Patent Application Publication
(10) Pub. No.: US 2026/0265863 A1
(43) Pub. Date: Sep. 10, 2026

(54) PROCESS

(71) Applicant: VELOCYS TECHNOLOGIES LTD, Oxford (GB)

(72) Inventors: Karl Kharas, Houston, TX (US); Jessica A. Muhlenkamp, Houston, TX (US); Dawid Duvenhage, Houston, TX (US); Lucas D. Schrader, Houston, TX (US); Kenneth Cowen, Houston, TX (US); Heinz J. Robota, Houston, TX (US)

(73) Assignee: VELOCYS TECHNOLOGIES LTD, Oxford (GB)

(21) Appl. No.: 19/167,283

(22) PCT Filed: Mar. 18, 2024
(86) PCT No.: PCT/EP2024/057191

§ 371 Date: Sep. 19, 2025

Related U.S. Application Data
(60) Provisional application No. 63/491,159, filed on Mar. 20, 2023.

(30) Foreign Application Priority Data
Apr. 11, 2023 (GB) 2305263.2

(51) Int. Cl. C22B 3/00; C22B 7/00

(52) U.S. Cl. CPC C22B 23/0415; C22B 7/007

(57) ABSTRACT

The invention concerns a leaching composition for extracting cobalt from a waste material, wherein the composition comprises at least one chemically active organic lixiviant comprising at least one weakly acidic hydroxyl group, the organic lixiviant being effective to alter the oxidation state of cobalt in the waste material and generate a soluble cobalt (II) ionic species comprising an anion derived from the organic lixiviant.

### TECHNICAL FIELD

The present invention concerns a leaching composition for extracting cobalt from a waste material, for example a catalyst, optionally a Fischer-Tropsch catalyst, and a process for selectivity separating cobalt from a waste material, which may be carried out in situ in a reactor. The present invention further provides steps for recovering and recycling the cobalt.

### BACKGROUND

The Fischer-Tropsch process is widely used to generate fuels from carbon monoxide and hydrogen and can be represented by the equation:

$$( 2 n + 1 ) {H}_{2} + n CO \to C n {H}_{2 n} + 2 + n {H}_{2} O$$

This reaction is highly exothermic and is catalysed by a Fischer-Tropsch catalyst, typically a cobalt-based catalyst, under conditions of elevated temperature (typically at least 180° C., e.g., 200° C. or above) and pressure (e.g., at least 10 bar). A product mixture is obtained, and n typically encompasses a range from 1 to 90. It is desirable to minimize light gas (e.g., methane) selectivity, i.e., the proportion of methane (n=1) in the product mixture, and to maximise the selectivity towards C5 and higher (n≥5) paraffins, typically to a level of 90% or higher. It is also desirable to maximize the conversion of carbon monoxide.

The hydrogen and carbon monoxide feedstock is normally synthesis gas.

During the Fischer-Tropsch reaction, the catalyst is gradually degraded, decreasing its effectiveness and requiring a gradual increase in temperature to maintain acceptable carbon monoxide conversion. This is described in Steynberg et al. “Fischer-Tropsch catalyst deactivation in commercial microchannel reactor operation” Catalysis Today 299 (2018) pp 10-13.

For a period of time, it is possible to regenerate the catalyst periodically, which can be done in situ by, for example, subjecting the catalyst to de-waxing, oxidation and reduction processes. However, there comes a point in the lifetime of the catalyst at which the accumulation of non-regenerable poisons such as sulfur and other non-regenerable deactivation mechanisms such as sintering cause the catalyst to become unviable. At this point the spent catalyst must be discharged from the reactor and replaced with fresh catalyst.

It is desirable to extract any material of value from the spent catalyst for reuse or recycle. In particular, it is desirable to extract metal from the catalyst—in the case of a Fischer-Tropsch catalyst, this may be cobalt.

Previous attempts to recover metals from Fischer-Tropsch catalysts have been made in the prior art.

WO2007/099365 describes a process for re-processing a Fischer-Tropsch catalyst comprising the steps of (i) de-waxing the Fischer-Tropsch catalyst, (ii) subjecting the de-waxed catalyst to hydrometallurgical leaching or extraction to separate catalyst metal or metals from catalyst support material, and (iii) recovering the separated catalyst metal or metals, wherein the de-waxing step is performed using a pressurized near-critical or supercritical fluid under conditions that minimize catalyst metal-support spinel formation.

The hydrometallurgical leaching is performed using acidic, alkaline or neutral aqueous solutions at elevated temperature and pressures. Suitable acids are said to include nitric acid, aqua-regia and sulfuric acids, and suitable alkalis are said to include sodium hydroxide and potassium hydroxide.

However, harsh process conditions are used along with strong inorganic acids which have associated disadvantages.

R. H. Matjie et al. “The selective dissolution of alumina, cobalt and platinum from a calcined spent catalyst using different lixiviants” Minerals Engineering 18 (2005) pp 801-810, describes an investigation into the selective dissolution of high value metals such as Co and Pt by leaching of calcined spent catalysts using different lixiviants such as sodium hydroxide, nitric acid, hydrochloric acid, sulfuric acid and aqua-regia.

US2010206134 describes a method for recovering metals from a spent catalyst composition containing an organic contaminant and catalytically active metals on a catalyst support. The metals are leached from the spent catalyst composition by adding under stirring an ionic liquid. The ionic liquid containing the leached metal is separated from the organic contaminant and the catalyst support by adding under stirring an anti-solvent. After removing the organic contaminant and the catalyst support, the leached metals are separated from the ionic liquid for example by selective precipitation, ion exchange, solvent extraction, electrodeposition, chromatographic, or pyrometallurgical methods.

US2012111150 describes a process for the selective recovery of Mo, V, Ni, Co and Al from spent hydroprocessing catalysts including the steps of treating the spent catalysts to recovery metals, support as well as chemicals. This process uses ultrasonic agitation for metal extraction and the presence of a chelating agent, particularly Ethylene Diamine Tetra-Acetic Acid (EDTA). The method includes acidification of the solution to pH 0.1 which would result in an EDTA precipitate.

US2019381483 describes the removal of catalyst and catalyst residues from reactors for the oxidative dehydrogenation of paraffins. The catalysts include mixed oxides of Mo, V, Nb, Te dissolved in aqueous solutions of oxalic acid.

KR20130138491 describes a method for collecting cobalt by performing leaching of cobalt and selective recovery. The leachate used in the method includes oxalic acid and at least one of malic acid and citric acid.

JP2009249740 describes a method for collecting a platinum group element and/or gold from a used material. The described method uses an oxalic acid solution.

CN115074554 describes a method for separating and recovering molybdenum and nickel from a waste hydrogenation catalyst. The method comprises carrying out oxygen-enriched roasting on the waste catalyst, leaching the roasted product with acetic acid, adding oxalic acid after leaching to form nickel oxalate precipitate, filtering and separating to obtain a nickel oxalate product, evaporating and crystallizing the solution to form molybdenum oxalate and molybdenum acetate, and finally converting the molybdenum oxalate and the molybdenum acetate into molybdenum trioxide by heating and decomposing.

The use of oxalic acid results in the formation of a leachate oxalate precipitate, which is insoluble.

CN107385214 describes a method for recovering valuable metals in a waste FCC catalyst through a sectional acidolysis. The described method uses acetic acid.

CN110923459 describes a method for recovering titanium-tungsten powder from a waste selective catalytic reduction catalyst. The method comprises adding oxalic acid for acid leaching, hydrofluoric acid for acid leaching and sulfuric acid solution for acid leaching in three steps.

U.S. Pat. No. 5,158,602 describes a method for separating copper (II) from chromite in a material containing both copper (II) and chromite. The method comprises (a) extracting the material with a combined hot vapor-liquid phase of volatile carboxylic acid to dissolve the copper (II) as cupric carboxylate, thereby removing the copper (II) from the material; and (b) crystallizing the cupric carboxylate.

One of the main problems associated with the hydrometallurgical leaching processes outlined in the prior art is the use of strong acids to leach out the metal component from the catalyst. Typically, inorganic acids, in particular nitric acid, sulfuric acid and hydrochloric acid are used as the lixiviant. Whilst these inorganic acids are effective at leaching metal from a catalyst, their use may result in the formation of hazardous waste, such as Cl₂, NOₓ and SO₂, which may negatively impact the environment. In addition, where strong acids are used, the catalyst must be removed from the reactor prior to treatment as the acid would damage components in the reactor—i.e., it is not possible to carry out the leaching process in situ in a reactor when such acids are used.

Acids have been shown effectively to leach various metals from spent lithium-ion batteries.

For example, Ascorbic acid has been shown to effectively leach soluble cobalt from battery waste—Ascorbic-acid-assisted recovery of cobalt and lithium from spent Li-ion batteries, Journal of Power Sources, Volume 218, 15 Nov. 2012, Pages 21-27. Additionally, Maleic, glycolic and acetoacetic acids have been shown to effectively recover metals from spent lithium-ion batteries (Liu B et al, 2019, Maleic, glycolic and acetoacetic acids-leaching for recovery of valuable metals from spent lithium-ion batteries: leaching parameters, thermodynamics and kinetics, Royal Society Open Science, Volume 6, (http://dx.doi.org/10.1098/rsos.191061)).

Alice Benedetto Mas et al, 2022, Analysis of Lanthanum and Cobalt Leaching Aimed at Effective Recycling Strategies of Solid Oxide Cells, Sustainability, Volume 14, (https://doi.org/10.3390/su14063335) describes the recovery of lanthanum and cobalt from solid oxide cells.

Alan T Stone, Hans-Jakob Ulrich, 1989, Kinetics and reaction stoichiometry in the reductive dissolution of manganese (IV) dioxide and co (III) oxide by hydroquinone, Journal of Colloid and Interface Science, Volume 132 (https://doi.org/10.1016/0021-9797 (89) 90265-8) describes the reductive dissolution of Mn(IV) dioxide and Co(III) oxide particles by hydroquinone which releases p-benzoquinone (Q) and reduced metal ions into solution.

However, in more complex waste material compositions (such as spent catalytic compositions) compared to spent lithium-ion batteries and solid oxide cells, cobalt may be present in more than one oxidation state and may be present as Co(0).

A further problem associated with the prior art, particularly if the waste material is in a reactor, is the use of acids to leach out the metal component that result in the formation of precipitates or insoluble material, which may be difficult to remove.

Thus, there remains a need in the art for the provision of a leaching composition that is capable of efficiently extracting and separating cobalt from a waste material utilizing less harmful acids without sacrificing leaching efficiency and providing a more environmentally friendly composition.

There also remains a need in the art for a process for separating and recovering metal cobalt from a catalyst, particularly a Fischer-Tropsch catalyst, which addresses the problems associated with the prior art processes and which allows the metal to be separated from the catalyst in situ in a reactor.

### SUMMARY OF INVENTION

According to a first aspect of the invention there is provided a leaching composition for extracting cobalt from a waste material, wherein the composition comprises at least one chemically active organic lixiviant comprising at least one weakly acidic hydroxyl group, the organic lixiviant being effective to alter the oxidation state of cobalt in the waste material and generate a soluble cobalt (II) ionic species comprising an anion derived from the organic lixiviant.

The waste material may contain cobalt in oxidation state Co(0). The waste material may additionally contain cobalt in oxidation state Co(III). The waste material preferentially comprises spent cobalt-containing catalyst.

According to a second aspect of the invention there is provided a leaching composition for extracting cobalt from a waste material, wherein the composition comprises at least one chemically active organic lixiviant comprising at least one weakly acidic hydroxyl group and at least one abstractable proton, the organic lixiviant being effective to alter the oxidation state of cobalt in the waste material at least from Co(0) and optionally also from Co(III) to generate a soluble cobalt (II) ionic species, optionally comprising an anion derived from the organic lixiviant.

Also provided in accordance with the invention is a waste material as described above in contact with at least one organic lixiviant as described above.

Preferably the at least one organic lixiviant is effective (directly or indirectly) to oxidise Co metal to Co (II). The lixiviant may additionally be effective to reduce Co(III) to Co(II).

The organic lixiviant may be a hydrogen donor and have the capacity to oxidise cobalt metal in situ and generate hydrogen gas.

By “weakly acidic” is meant a pKa of ≥2, for example from 2-13.

By “soluble” is meant that the Co(II) ionic species has a solubility of at least about 0.008 g/ml, preferably at least about 0.016 g/ml in water at RTP.

When the organic lixiviant comprises more than one acidic hydroxyl group, preferably all the acidic hydroxyl groups present are only weakly acidic.

The inventors of the present invention have surprisingly found that a leaching composition according to the present invention improves cobalt extraction from waste materials compared to leaching compositions of the prior art, with the use of less harsh conditions. The leaching composition increases cobalt recovery from waste materials, thereby increasing recovery and re-use or recycle of cobalt.

It has advantageously been found that a chemical leaching composition according to the invention can be used for selectively separating cobalt from a waste material, for example a cobalt catalyst. This leaching composition has been found to be particularly effective at separating cobalt from a cobalt-based Fischer-Tropsch catalyst.

By subjecting the waste material, for example a catalyst, to chemical leaching in the presence of a leaching composition described herein, the cobalt is leached i.e., separated, from the catalyst. The cobalt can then advantageously be recovered and re-used or recycled.

Prior art leaching compositions and processes for cobalt-based catalysts have tended to use strong acids, such as hydrochloric acid, nitric acid and/or sulfuric acid, as the lixiviant. However, such acids have numerous disadvantages, for example they are difficult to handle, may produce hazardous waste and are unsuitable for use in a reactor as they can damage components therein.

Conversely, the leaching composition of the present invention comprises milder reagent(s) and can be used in a reactor without damaging its components, thereby efficiently extracting cobalt from a waste material without attacking reactor components. This affords further advantages, particularly if the waste material is to be discharged from a reactor.

It has been found that a leaching composition according to the above provides efficient extraction of cobalt from waste materials. The leaching composition according to the invention may advantageously have multiple functionalities.

Contacting the leaching composition of the invention with the waste material may advantageously contact Co(0) in the waste material with protons donated by the organic lixiviant, resulting in the reduction of the protons by Co(0) and concomitant oxidation of Co(0) to Co(II) in situ.

It has further been found that a leaching composition that is able to reduce cobalt(III) to cobalt(II) increases the cobalt extraction capability of the leaching composition, with cobalt(II) being more stable and readily dissolvable than cobalt(III). This increase in cobalt dissolution advantageously increases the cobalt extraction capability of the leaching composition.

The leaching composition of the invention can advantageously be used to extract cobalt from a wide range of waste materials. Particularly those in which Co may be present in more than one, or in an unpredictable, oxidation state of Co, i.e., the Co oxidation state may be variable.

Preferably, the waste material is a catalyst. The catalyst may be a fresh, used and/or a spent catalyst. The term “used catalyst” is to be understood as a fresh catalyst that has been used in at least one catalytic process. The term “spent catalyst” is to be understood as a catalyst that no longer exhibits the necessary activity required by the process.

In some embodiments, fresh, used and spent catalyst may be present, for example, in different locations of a reactor. The leaching composition may be used to leach cobalt from a catalyst in a reactor. The leaching composition of the invention has been found effectively to leach different species of cobalt, therefore providing a simpler, more efficient route to leaching cobalt, without the need for multiple different compositions and/or leaching stages.

The leaching composition may have the capability to form a soluble ionic species with cobalt(II). This advantageously avoids the formation of poorly soluble or insoluble byproducts, which, in turn, increases recovery of cobalt from the waste material.

The soluble ionic species may comprise a metal salt i.e., cobalt is dissolved by the leaching composition to form a cobalt salt. Non-limiting examples of suitable soluble cobalt salts include cobalt glycolate, cobalt lactate, cobalt acetate and cobalt ascorbate. The inventors of the present invention have found that the composition of the present invention is capable of forming cobalt(II) ionic species which are soluble. This increases solubility of the cobalt, which in turn, increases recovery and extraction of the cobalt, thereby improving the overall leaching efficiency of the composition.

The cobalt salts tend to be water soluble. In particular, cobalt glycolate, cobalt lactate and cobalt acetate are all very water soluble. This has the advantage of enabling any precipitated cobalt salt (which may form during leaching) to be dissolved and washed away using water. This is particularly advantageous when chemical leaching is carried out in a reactor for example, as water can simply be flowed through the reactor to dissolve and wash away any precipitated metal salt. The formation of precipitates which are not soluble is undesirable and would hinder the extraction of cobalt. For example, insoluble cobalt compounds, such as cobalt(II) oxalate, would result in the formation of a precipitate that is not easily removed from its location. For example, where the waste material is a catalyst in a reactor, the precipitate formed would not easily be removed from a reactor, which is unfavourable.

The leaching composition may have dual or multiple functionalities. For example, the leaching composition may advantageously have reducing capabilities in addition to the ability to form soluble ionic species. This is particularly advantageous where there may be variety of cobalt species present in the waste material.

According to another aspect of the invention there is provided a process for extracting cobalt from a waste material, comprising the step of subjecting the waste material to chemical leaching in the presence of a leaching composition described herein to separate cobalt from the waste material.

The process may be carried out in a reactor. The inventors have found that the leaching composition of the invention provides improved leaching efficiency of cobalt from waste materials.

A number of different reactor types are known for carrying out Fischer-Tropsch synthesis, including fixed bed reactors and microchannel reactors (Rytter et al. “Deactivation and Regeneration of Commercial Type Fischer-Tropsch Co-Catalysts—A Mini-Review” Catalysts (2015), 5, pp 478-499 at 483-483).

Microchannel reactors are disclosed in WO2016/201218 in the name of the present applicant, the contents of which are incorporated herein by reference, and similarly in LeViness et al. “Velocys Fischer-Tropsch Synthesis Technology—New Advances on State-of-the-Art” Top Catal (2014), 57, pp 518-525. Such reactors have the particular advantage that very effective heat removal is possible owing to the high ratio of heat exchange surface area to microchannel (and hence catalyst) volume.

The inventors of the present invention have surprisingly found that when the chemical leaching step is carried out in situ in a reactor, for example a microchannel reactor, packed with cobalt-based catalyst, at least some of the cobalt, is separated from the catalyst substrate and can subsequently be removed from the reactor, preferably as a cobalt salt. Discharge of the cobalt-depleted catalyst can be carried out using known techniques, for example ultrasonic agitation and/or using a stream of compressed air. Such techniques are disclosed in WO2009061416 and WO2021207622, by way of example, and the contents thereof are herein incorporated by reference.

It will be apparent that when conducting the leaching step in situ, the leaching composition may be introduced into either end (or into both ends) of the reactor. If the reactor contains reactor channels through which in operation reagent flows from an inlet end towards an outlet end, then in operation of the process of the invention it is envisaged that the leaching composition may be introduced into either the inlet end or into the outlet end, or it may conceivably be introduced at both ends. Leachate may be recovered from the same, or a different, end from that into which the leaching composition is introduced.

The inventors of the present invention have further surprisingly found that mild process conditions can be used for the chemical leaching step despite using a relatively weak acid, phenol or phenolic derivative such as hydroquinone (e.g. p-hydroquinone, m-hydroquinone and/or o-hydroquinone). For example, chemical leaching may be carried out at a temperature of about 100° C. or less and a pressure of about 25 bar or less. It has even been found possible to carry out the chemical leaching step at ambient temperature and pressure.

Overall, the process of the present invention enables cobalt to be separated from a fresh, used and/or spent catalyst and recovered for reuse or recycle. This is particularly advantageous where the metal is cobalt as some sections of the market prefer “conflict-free” cobalt, which may trade at a premium.

An advantageous feature of the present invention is the use of a relatively weak acid, in the chemical leaching step and the formation of a cobalt soluble species. This enables the process to be carried out in situ in a reactor. Thus, according to another aspect of the invention there is provided a process for selectively separating a metal from a catalyst in a reactor, comprising the steps of: de-waxing the catalyst; optionally oxidising the de-waxed catalyst; subjecting the optionally oxidised catalyst to chemical leaching in the presence of a leaching composition to separate the metal from the catalyst substrate; and recovering the leached metal from the reactor.

In the description that follows, it will be understood that all features relating to one aspect of the invention may also apply, where appropriate, to all other aspects of the invention and vice versa.

### DETAILED DESCRIPTION

The present invention relates to a leaching composition for extracting cobalt from a waste material.

The leaching composition advantageously exhibits at least one, at least two, or all of the following properties:
the capacity to:
i) donate hydrogen to oxidise Co(0) and concomitantly produce hydrogen gas in situ;
ii) the ability to reduce cobalt(III) to cobalt(II); and/or
iii) form a soluble ionic species with cobalt(II).

The leaching composition may advantageously have multiple functionality, for example, the leaching composition may be able to efficiently reduce cobalt(III) and also form a soluble ionic species with cobalt(II). Therefore, the leaching composition has been found to be effective at leaching a variety of waste materials.

The leaching composition may additionally, or alternatively, oxidise cobalt metal to cobalt(II).

The waste material may be a catalyst. The catalyst may be a Fischer-Tropsch catalyst.

The catalyst may optionally have a cobalt loading in the range from about 10% to about 60% by weight, or from about 15% to about 60% by weight, or from about 20% to about 60% by weight, or from about 25% to about 60% by weight, or from about 30% to about 60% by weight, or from about 32% to about 60% by weight, or from about 35% to about 60% by weight, or from about 38% to about 60% by weight, or from about 40% to about 60% by weight, or from about 40% to about 55% by weight, or from about 40% to about 50% by weight, or from about 45% to about 60% by weight, or from about 45% to about 55% by weight, or from about 50% to about 60% by weight, or from about 50% to about 55% by weight, of cobalt.

The catalyst may optionally have a cobalt particle size and/or an average cobalt particle size of from about 5 nm to about 20 nm, or from about 5 nm to about 15 nm, or from about 6 nm to about 12 nm, or from about 8 nm to about 10 nm. The catalyst may optionally have a cobalt particle size and/or an average cobalt particle size of less than about 20 nm, or less than about 19 nm, or less than about 18 nm, or less than about 17 nm, or less than about 16 nm, or less than about 15 nm, or less than about 14 nm, or less than about 13 nm, or less than about 12 nm, or less than about 11 nm.

The catalyst may optionally further comprise a noble metal. The noble metal may be one or more of Pd, Pt, Rh, Ru, Re, Ir, Au, Ag and Os. The noble metal may be one or more of Pt, Ru and Re. The noble metal may be Ru and/or Pt. The catalyst may optionally comprise from about 0.01% to about 30% in total of noble metal(s) (based on the total weight of all noble metals present as a percentage of the total weight of the catalyst), or from about 0.01% to about 3% in total of noble metal(s), or from about 0.05% to about 20% in total of noble metal(s), or from about 0.05% to about 1% in total of noble metal(s), or from about 0.1% to about 5% in total of noble metal(s), or from about 0.1% to about 0.5% in total of noble metal(s), or about 0.2% in total of noble metal(s).

The catalyst may optionally comprise one or more other metal-based components as promoters or modifiers. These metal-based components may optionally also be present in the catalyst as carbides, oxides or elemental metals. A suitable metal for the one or more other metal-based components may for example be one or more of Zr, Ti, V, Cr, Mn, Ni, Cu, Zn, Nb, Mo, Cd, Hf, Ta, W, Re, Hg, Tl and the 4f-block lanthanides. Suitable 4f-block lanthanides may be La, Ce, Pr, Nd, Sm, Eu, Gd, Tb, Dy, Ho, Er, Tm, Yb and/or Lu. The metal for the one or more other metal-based components may for example be one or more of Zn, Cu, Mn, Mo and W. The metal for the one or more other metal-based components may for example be one or more of Re and Pt. The catalyst may optionally comprise from about 0.01 to about 10% in total of other metal(s) (based on the total weight of all the other metals as a percentage of the total weight of the catalyst), or optionally from about 0.1 to about 5% in total of other metals, or optionally about 3% in total of other metals.

The catalyst may comprise a support. The support may optionally comprise a refractory metal oxide, carbide, carbon, nitride, or mixture of two or more thereof. The support may optionally comprise alumina, zirconia, silica, titania, or a mixture of two or more thereof. The surface of the support may optionally be modified by treating it with silica, titania, zirconia, magnesia, chromia, alumina, or a mixture of two or more thereof. The material used for the support and the material used for modifying the support may be different.

The support may optionally or preferentially comprise silica. The surface of the silica may be treated with a refractory solid oxide such as titania. The material used to modify the support may be used to increase the stability (e.g., by decreasing deactivation) of the supported catalyst. The catalyst support may optionally comprise up to about 30%, for example up to about 35%, 40%, 45%, 50% or more by weight of the oxide (e.g., silica, titania, magnesia, chromia, alumina, or a mixture of two or more thereof) used to modify the surface of the support, or from about 1% to about 30% by weight, or from about 2% to about 20% by weight, or from about 3% to about 15% by weight, or from about 4% to about 10% by weight, or from about 5% to about 30% by weight, or from about 5% to about 25% by weight, or from about 5% to about 8% by weight, or from about 10% to about 20% by weight, or from about 12% to about 18% by weight, for example.

The catalyst support may optionally be in the form of a structured shape, pellets or a powder. The catalyst support may optionally be in the form of particulate solids.

The catalyst may have any size and geometric configuration that makes it suitable for its intended use, for example in a reactor such as a fixed bed reactor or microchannel reactor. The catalyst may optionally be in the form of particulate solids (e.g., pellets, powder, fibres, and the like) having a median particle diameter of about 1 to about 1000 μm (microns), or about 10 to about 750 μm, or about 25 to about 500 μm. The median particle diameter may optionally be in the range from 50 to about 500 μm or about 100 to about 500 μm, or about 125 to about 400 μm, or about 170 to about 300 μm. It is also envisaged that fixed bed FT catalysts such as the extrudates described in U.S. Pat. No. 9,005,538 are encompassed within the scope of catalysts that may be treated in accordance with the invention.

The organic lixiviant in the leaching composition may comprise a carboxylic acid, a non-carboxylic acid such as ascorbic acid, a phenol or a phenolic derivative such as hydroquinone, or suitable combinations thereof. In embodiments where the leaching composition comprises a mixture or combination of different components, the different components may be added to the waste material separately or together.

Examples of suitable phenolic derivatives may include, but are not limited to, cresol, 2,6-di-tert-butyl-4-methylphenol, hydroquinone and tyrosine.

Acids comprising the organic lixiviant, or acids comprising part of the organic lixiviant, may have at least one pKa value of from about 2 to about 6. Such acids may have at least one pKa value of from about 3 to about 5. In this context, by “pKa value” of the acid we mean the hydrogen in at least one carboxyl group of the acid has a pKa value as stated. Examples of carboxylic acids, ascorbic acid and the associated pKa values are shown in the below table:

| Acid | CAS No. | pKa |
|---|---|---|
| Glycolic acid | 79-14-1 | 3.83 |
| Lactic acid | 79-33-4 | 3.86 |
| Acetic acid | 64-19-7 | 4.76 |
| Citric acid | 77-92-9 | 3.1, 4.7, 6.4 |
| Formic acid | 64-18-6 | 3.77 |
| Ascorbic acid | 50-81-7 | 4.17 |

The acid may be a carboxylic acid, in which case it may comprise glycolic acid, lactic acid, formic acid, citric acid, acetic acid and/or aqueous solutions thereof and suitable combinations of two or more thereof. The acid may be a non-carboxylic organic acid, in which case it may be ascorbic acid. In some embodiments, the leaching composition may include at least one carboxylic acid and at least one non-carboxylic organic acid.

Other suitable organic lixiviants such as hydroquinone may have higher pKa values (ca. 9.96 in the case of hydroquinone; 10.9 in the case of tyrosine; 10.26 in the case of p-cresol, 12.75 in the case of 2,6-di-tert-butyl-4-methylphenol). Such materials may often be useful as hydrogen or proton donors in the leaching composition.

The leaching composition may comprise a suitable adjuvant, for example a chelating adjuvant such as EDTA or other polyfunctional amine. Therefore, the organic lixiviant may be provided in combination with at least one compatible adjuvant or excipient. For example, the carboxylic acid, ascorbic acid, phenol or phenolic derivative may be provided in combination with a suitable adjuvant—for example a chelating adjuvant such as EDTA or other polyfunctional amine. Other adjuvants or excipients that may be used (alone or in combination) include surfactants, PEGs, PPGs, alcohols, ethers, esters and anhydrides or suitable combinations of two or more thereof. It is also contemplated to provide additional oxidising and/or reducing agents (such as hydrogen peroxide) in the leaching composition.

In practice, the leaching composition used may comprise additional components, for example water. For example, the carboxylic acid may also comprise trace amounts of other components, for example formic acid and methyl acetate. As a specific example, and in no way limiting, technical grade glycolic acid may comprise 70% glycolic acid, around 30% water and trace amounts of formic acid and methyl acetate. However, it should be appreciated that higher aqueous concentration may be contemplated, as the Examples herein will demonstrate.

It may be preferable for the carboxylic acid to comprise a hydroxycarboxylic acid, for example glycolic acid and/or lactic acid. Without wishing to be bound by any such theory, the inventors of present invention recognise that hydroxycarboxylic acids have higher complexation equilibrium constants compared to other carboxylic acids, particularly for cobalt salts. A higher complexation equilibrium constant facilitates dissolution and separation of the metal e.g., cobalt, from the catalyst substrate. (See Pure Appl. Chem, vol 75, 495-540, 2003, “Critical evaluation of stability constants for alpha-hydroxycarboxylic acid complexes with protons and metal ions and the accompanying enthalpy changes Part II. Aliphatic 2-hydroxycarboxylic acids” and Journal of Inorganic and Nuclear Chemistry, vol 43, 1011-1016, 1981, “Temperature dependences of the formation constants of the cobalt(II) acetate complexes”.).

Preferably, in some embodiments, the leaching composition comprises glycolic acid.

Preferably, in other embodiments, the leaching composition comprises ascorbic acid.

In some embodiments, the leaching composition may comprise at least one carboxylic acid and at least one non-carboxylic acid. In some embodiments, the leaching composition may comprise at least one carboxylic acid and ascorbic acid. Preferably, the leaching composition comprises glycolic acid and ascorbic acid.

Chemical leaching may be carried out at ambient temperature. In this context, by “ambient temperature” it is meant the temperature of the immediate surroundings i.e., without additional heating or cooling. For example, “ambient temperature” may mean a temperature of from about 15° C. to about 25° C., but may be higher—e.g. up to about 30° C., 40° C., 45° C. or more in some climates.

Alternatively, chemical leaching may be carried out at an elevated temperature. Preferably, chemical leaching is carried out at an elevated temperature that is less than the flash point temperature of the organic lixiviant.

For example, the elevated temperature may be between ambient temperature and about 100° C. or less, about 90° C. or less, about 80° C. or less, about 70° C. or less, about 60° C. or less, about 50° C. or less, about 40° C. or less, or about 30° C. or less. The elevated temperature may between about 20° C. and 100° C., between about 20° C. and 90° C., between about 40° C. and 90° C.

The optimal temperature will depend on many factors, including the composition of the leaching composition (for example, the nature of the organic lixiviant(s) used and the type of catalyst present). However, the overall aim is to operate the process at the lowest possible temperature that still provides practically useful cobalt leach rates. As a specific example, chemical leaching may be carried out at a temperature of from about 20° C. to about 90° C. This temperature range may be a preferred range when the leaching composition comprises a carboxylic acid, wherein the carboxylic acid comprises glycolic acid. As a further non-limiting example, chemical leaching may be carried out at a temperature from about 60° C. to about 90° C. when the leaching composition comprises ascorbic acid.

Chemical leaching may be carried out at ambient pressure.

Alternatively, chemical leaching may be carried out at a raised pressure. However, it is still preferable for the pressure to be kept as low as practically possible. For example, the pressure may be no greater than about 25 bar, or no greater than about 20 bar.

The optimal pressure will depend on many factors, but notably the size of the catalyst particles. Typically, smaller catalyst particle sizes will require a higher pressure.

The raised pressure may be provided by an inert gas, for example nitrogen or argon. Where the process is carried out in a reactor, the inert gas may be flowed through the reactor to increase the pressure and facilitate transport of the leaching composition, through the reactor.

In some embodiments, the chemical leaching step can be carried out at ambient temperature and pressure.

The process may separate at least about 10% by weight, at least about 15% by weight, at least about 20% by weight, at least about 25% by weight, at least about 30% by weight, at least about 35% by weight, or at least about 40% by weight of the metal from the catalyst. In some embodiments, the process may separate at least about 60% by weight, at least about 70% by weight, even as high as about 80%, 85%, 90% or 95% by weight of the metal from the catalyst.

The process may be carried out in a reactor.

As previously outlined, a significant advantage of using a leaching composition as described herein is that it enables the chemical leaching step to be carried out in a reactor without damaging the reactor components.

The reactor may be a fixed bed reactor or a microchannel reactor, or in trickle bed, bubble column reactors, or in any shell/tube reactor-such as those described in U.S. Pat. No. 9,005,538 as previously mentioned in connection with catalytic geometry. In some cases slurry bubble column reactors may also be treated by means of the inventive process subject to effective wax removal prior to such treatment. Preferably, the reactor is a microchannel reactor. Examples of suitable microchannel reactors are disclosed in WO2016201218 in the name of the present applicant, the contents of which are incorporated herein by reference, and similarly in LeViness et al. “Velocys Fischer-Tropsch Synthesis Technology—New Advances on State-of-the-Art” Top Catal (2014), 57, pp 518-525.

Water may be simultaneously or subsequently flowed through the reactor. The water may dissolve any precipitated metal salt that can then be recovered from the reactor as the water flows from the reactor outlet.

The process may additionally comprise the step of de-waxing, optionally followed by oxidising, the catalyst prior to chemical leaching. Other treatments such as wax reduction (WR), wax reduction followed by oxidation (WRO), wax reduction followed by oxidation and subsequent reduction (WROR), high temperature hydrogen removal (HTHR), high temperature hydrogen removal followed by passivation (HTHR-P), may be contemplated prior to the carboxylic acid leaching. These procedures generate a catalyst comprising a metallic element (Co) and/or a range of metal (Co) oxides, depending on the treatment selected.

The catalyst may be de-waxed by treating it at an elevated temperature with a hydrogen-containing de-waxing gas stream flowing through the reactor e.g., through process microchannels.

The de-waxing gas stream may comprise hydrogen and optionally a diluent gas. The diluent gas may, for example, comprise (or be) nitrogen, methane or light hydrocarbons.

The elevated temperature for de-waxing may be in the range of from about 300° C. to about 400° C., from about 330° C. to about 380° C., or from about 340° C. to about 360° C. The temperature may be kept at or near (preferably within 15° C. of) that temperature for a period of about one hour to about 24 hours, or from about 10 hours to about 20 hours, or from about 10 hours to about 15 hours.

The above temperatures for de-waxing may be the preferred temperatures for cobalt-based Fischer-Tropsch catalysts, but it will be appreciated that different types of catalyst may require alternative temperatures to be used, the selection of which is well within the remit of the skilled addressee.

As mentioned previously, the process may additionally comprise the step of oxidising the de-waxed catalyst.

After completion of the de-waxing step, a purge with an inert gas e.g., nitrogen, may be completed prior to the oxidising step.

The de-waxed catalyst may be oxidised by treating it at an elevated temperature with an oxidising gas stream flowing through the reactor e.g., through process microchannels.

The oxidising gas stream may comprise oxygen and a diluent gas. The oxygen content of the oxidising gas stream may be about 21% or less by volume, about 15% or less by volume, about 10% or less by volume, about 5% or less by volume, or from about 1% to about 4% by volume.

The diluent gas may, for example, comprise (or be) air, nitrogen, argon, helium or carbon dioxide.

The elevated temperature for the oxidising step may be in the range of from about 250° C. to about 325° C., or from about 280° C. to about 300° C. The temperature may be kept at or near (preferably within 15° C. of) that temperature for a period of about one hour to about 24 hours, or from about 10 hours to about 20 hours, or from about 10 hours to about 15 hours. Conditions such as those described in WO2020249529 (the contents of which are hereby incorporated by reference) may be selected. Alternatively, HTHR at temperature up to about 350° C. followed by passivation at 80-100° C. in dilute O₂ may be employed.

Again, the above temperatures for oxidising the catalyst may be the preferred temperatures for cobalt-based Fischer-Tropsch catalysts, but it will be appreciated that different types of catalyst may require alternative temperatures to be used, the selection of which is well within the remit of the skilled addressee.

Typically following oxidative pre-treatment of the catalyst it will not be necessary (or perhaps undesirable for the purposes of effective leaching) then reductively to pre-treat the catalyst prior to leaching. However, reduction of the catalyst following oxidative pre-treatment may be an essential step in regenerating the catalyst and so in some cases it may be envisaged to provide conditions effective for in situ reduction and leaching of the catalyst.

The leached cobalt may be further treated to obtain the cobalt in a suitable form for reuse or recycle. For example, where the leached cobalt is in the form of a cobalt salt, the cobalt salt may be treated with a cation exchange material. The cation exchange material absorbs the cobalt from the cobalt salt. The cation exchange material can subsequently be regenerated which releases the aqueous cobalt. This also allows recycle of the organic acid which may be more expensive than the cobalt salt (perhaps cobalt sulphate) that is released from the cation exchange material. (Aqueous H₂SO₄ is typically expected to be cheaper than aqueous glycolic acid, for example.)

The cobalt may also be recovered through the addition of a precipitating agent, such as sodium carbonate or sodium bicarbonate, which reacts with the cobalt salt forming a precipitate. The resulting precipitated cobalt species, such as cobalt carbonate, can then be readily separated/recovered from the liquid phase.

By recovering cobalt from the used or spent catalyst, efficient recycle of the cobalt can occur. In the case of cobalt, this may be particularly advantageous as some sections of the market prefer “conflict-free” cobalt which may trade at a premium. In addition, regeneration of the cation exchange material releases aqueous carboxylic acid which can be reused to separate further cobalt from the catalyst. It should be apparent that the process of the invention may be applied to fresh catalyst as well as spent catalyst.

The process may additionally comprise the step of discharging the metal-depleted catalyst substrate from the reactor.

The metal-depleted catalyst substrate may be discharged from the reactor using ultrasonic agitation. Such ultrasonic agitation techniques are known from the prior art, for example as disclosed in WO2009061416 and WO2013013077 in the name of the present applicant, the contents of which are incorporated herein by reference.

Additionally or alternatively, the cobalt-depleted catalyst substrate may be discharged from the reactor using a stream of compressed air. Such techniques are known from the prior art, for example as disclosed in WO2021207622 in the name of the present applicant, the contents of which are incorporated herein by reference.

Additionally or alternatively, the cobalt-depleted catalyst may be discharged from the reactor using an external magnet.

There is further provided a process for selectively separating cobalt from a waste material in a reactor, wherein the waste material is a catalyst, comprising the steps of: a. de-waxing the catalyst; b. optionally oxidising the de-waxed catalyst; c. subjecting the optionally oxidised catalyst to chemical leaching in the presence of a leaching composition described herein to separate the cobalt from the catalyst substrate; and d. recovering the leached cobalt from the reactor.

### EXAMPLES

The invention will now be more particularly described with reference to the following, non-limiting examples.

### Example 1

An experiment was carried out to separate cobalt from a cobalt-based Fischer-Tropsch catalyst using a Soxhlet extractor and 70% glycolic acid in water.

Approximately 150 ml of 70% glycolic acid solution was added to a round bottom flask at the bottom of a Soxhlet extractor. Approximately 1 g of cobalt-based Fischer-Tropsch catalyst was placed in a cellulose thimble in the middle of the extractor. At the top of the extractor was a condenser connected to a chiller/circulator bath set to 15° C. and vented through a mineral oil bubbler. The entire extractor was purged with a slow flow of nitrogen throughout the experiment.

The round bottom flask was heated using a heating jacket to the boiling point of the solvent. The solvent then condensed and refluxed into the thimble. The extractor was operated for approximately 4-5 hours. The temperature in the thimble during the extraction was approximately 70-80° C.

Cobalt content in the solution after the extraction was analysed by titration with EDTA as described in Sharma, Fresenius' Zeitschrift für Analytische Chemie 253 (1971) pp 37. Succinimide and ammonia were used as the indicator. The pH was adjusted to 9.4-10 using ammonium hydroxide and sodium hydroxide. Sodium thiosulfate was used as a copper masking agent as previously described in Malik & Sharma, Fresenius' Zeitschrift für Analytische Chemie 244 (1969) pp 317.

The experiment resulted in the extraction of approximately 30% by weight of the cobalt present in the initial catalyst.

### Example 2

An initial extraction was carried out in the same way as described in Example 1. After the initial extraction, a second extraction was conducted on the same catalyst sample in the same manner as the first extraction, using a fresh aliquot of 70% glycolic acid solution (150 ml).

Following the second extraction, analysis of the cobalt content in the resulting solution was conducted in the same manner as outlined in Example 1 excluding the sodium thiosulfate masking agent.

The experiment resulted in the extraction of approximately 40% by weight of the cobalt present in the initial catalyst.

### Example 3

Approximately 500 mg of cobalt-based Fischer-Tropsch catalyst was added to approximately 30 ml of 70% glycolic acid solution in a beaker. The resulting slurry was stirred for approximately 4 hours without any external heating, at a room temperature of 20° C. The slurry was allowed to settle for approximately an hour and was then centrifuged to separate the solid from the liquid. The cobalt content of the resulting solution was analysed in the same manner as outlined in Example 2.

The experiment resulted in the extraction of approximately 45% by weight of the cobalt present in the initial catalyst.

### Example 4

Approximately 5 g of cobalt-based Fischer-Tropsch catalyst was loaded into a burette on top of a plug of quartz wool. The packed bed density of the resulting catalyst bed was approximately 1 g/ml.

5 ml of water followed by 40 ml of 70% glycolic acid was flowed through the catalyst bed. Precipitate formation was observed in the resulting solution after exiting the burette. The cobalt content of the resulting solutions and dissolved precipitates was analysed in the same manner as outlined in Example 2.

The experiment resulted in the extraction of approximately 40% by weight of the cobalt present in the initial catalyst.

### Example 5

Approximately 500 mg of cobalt-based Fischer-Tropsch catalyst was added to approximately 30 ml of >85% lactic acid solution in a beaker. The resulting slurry was stirred for approximately 4 hours without any external heating, at a room temperature of 20° C. The slurry was allowed to settle for approximately an hour and was then centrifuged to separate the solid from the liquid. The cobalt content of the resulting solution was analysed in the same manner as outlined in Example 2.

The experiment resulted in the extraction of approximately 10% by weight of the cobalt present in the initial catalyst.

### Example 6

This example proceeded the same as Example 4 except an approximately 35 wt % aqueous glycolic acid solution was used in place of 70% aqueous glycolic acid. Approximately 36% of the Co in the initial catalyst sample was extracted. Additionally, no precipitate formation was observed in the resulting extraction solution.

### Example 7

Experiments were conducted in the same manner as Example 3 except using aqueous glycolic acid solutions of 35 wt. %, 24 wt. % and 18 wt. % instead of 70% aqueous glycolic acid solution. The resulting Co extracted was approximately 55%, 50% and 50% respectively.

### Example 8

In this example approximately 0.25 g of a Co Fischer-Tropsch catalyst was used. The sample was placed into a beaker with 70 wt. % aqueous glycolic acid solution for 6 hr without stirring. The Co content was analysed in the same manner as Example 1. Approximately 65% of the Co in the initial catalyst sample was extracted.

### Example 9

In this example a 35 wt. % aqueous glycolic acid solution was introduced into a micro channel reactor arranged and previously operated as described in WO2016201218 (the contents of which are hereby incorporated by reference). Before further treatment the catalyst was subjected to a wax removal, oxidation, reduction process as described in WO2020249529 (the contents of which are hereby incorporated by reference) followed by passivation in air diluted in nitrogen at approximately 100° C. The solution was introduced at the top of the reactor, allowed to flow through the channels with the force of gravity, and was collected at the bottom of the reactor. First the region was exposed to 50 ml of 35 wt. % aqueous glycolic acid solution, followed by rinsing with 100 ml of water and 150 ml of ethanol. The solutions were analyzed for Co content in the same manner as Example 1. Approximately 20% of the Co in the catalyst exposed to the extraction process was removed.

### Example 10

This example proceeded in the same manner as Example 4 except instead of an aqueous glycolic acid solution a solution comprising a mixture of citric acid and sodium EDTA was used. Citric acid and sodium EDTA both interfere with the Co titration method used in the previous examples. Therefore, the mass loss of the catalyst before and after extraction was used to estimate that approximately 10% of the Co was extracted from the catalyst.

### Example 11

An experiment was carried out to separate cobalt from a fresh cobalt-based Fischer-Tropsch catalyst using a leaching composition according to the invention, the different leaching compositions can be found in Table 1 below. For Examples 11 to 13, the experiments consisted of approximately 500 mg of catalyst and 30-50 ml of extraction solution.

For the room temperature example listed in Table 1 the fresh catalyst and leaching solution were combined in a beaker and left overnight. The solution was then filtered to separate the remaining solid from the solution.

For the heated examples listed in Table 1, the fresh catalyst and leaching solution were combined in a round bottom flask. A condenser was added and then the flask was heated using a heating jacket. The solution was heated over the course of approximately 1 hour and then held at temperature for a further hour. Any discrepancies in the temperature and time are noted in Table 1. The solution was allowed to cool and filtered to separate the remaining solid from the solution.

Cobalt content in the solution after the extraction was analysed by titration with EDTA as described in Sharma, Fresenius' Zeitschrift für Analytische Chemie 253 (1971) pp 37. Succinimide and ammonia were used as the indicator. The pH was adjusted to 9.4-10 using ammonium hydroxide and sodium hydroxide.

A summary of the leaching composition, temperature, time and resulting % cobalt extracted from the fresh cobalt-based Fischer Tropsch catalyst can be found in Table 1.

TABLE 1

| | | | Wt. % Cobalt |
|---|---|---|---|
| Leaching Composition | Temperature | Time | Extracted |
| 35 wt. % glycolic acid | Room | Overnight | 3 |
| | Temperature | | |
| 35 wt. % glycolic acid | 80-90° C. | 2 hours | 30 |
| 15 wt. % glycolic acid + | 80-90° C. | 2 hours | 60 |
| 2 vol. % H₂O₂ | | | |
| 18 wt. % ascorbic acid | 80-90° C. | 2 hours | 92 |
| 18 wt. % ascorbic acid + | 80-90° C. | 2 hours | 93 |
| 15 wt. % glycolic acid | | | |

The leaching efficiency of glycolic acid for the fresh cobalt-based catalyst improved with an increased temperature and significantly improved when used in combination with ascorbic acid.

Heated ascorbic acid was shown to be an effective leaching agent, achieving over 90% cobalt extraction at a low concentration and mild conditions. The leaching composition can recover cobalt at a relatively low temperature from a fresh catalyst, and without the use of strong acids.

### Example 12

This example proceeded the same as the tests in Example 11, except a variety of different fresh and used cobalt-based Fischer-Tropsch catalysts were leached (see Table 2). The temperature of the hot ascorbic acid (18 wt. %) was approximately 80-90° C. and glycolic acid (15 wt. %) was at room temperature (i.e., ambient temperature).

A variety of used catalysts were leached using a leaching composition according to the invention.

Used cobalt-based catalysts A to F were operated in multichannel microchannel reactors.

Used catalyst A was operated within normal operating conditions for a F-T reaction using biomass derived syngas for approximately 1600 hours.

Used catalysts B to E were from different locations of a reactor operated under more severe conditions than used catalyst A for approximately 2500 hours.

Used catalyst F was operated under more severe conditions than used catalysts A to E for approximately 2600 hours.

TABLE 2

| | | Wt. % Cobalt |
|---|---|---|
| | Wt. % Cobalt | Extracted with |
| | Extracted with Hot | Room Temperature |
| Waste Material | Ascorbic Acid | Glycolic Acid |
| Fresh cobalt-based catalyst A | 92 | 3 |
| Used cobalt-based catalyst A | 98 | 87 |
| Used cobalt-based catalyst B | 92 | 75 |
| Used cobalt-based catalyst C | 88 | 49 |
| Used cobalt-based catalyst D | 85 | 23 |
| Used cobalt-based catalyst E | 82 | 77 |
| Used cobalt-based catalyst F | 53 | 15 |

Leaching compositions comprising glycolic acid showed improved leaching capabilities for used catalyst compared to fresh catalysts.

Leaching compositions comprising hot ascorbic acid showed excellent leaching capabilities for extracting cobalt from a variety of fresh and used catalysts.

Without wishing to be bound by theory, it appears that catalysts containing cobalt phyllosilicate are more resistant to hot ascorbic acid (for example, used cobalt-based catalyst F) as a leaching agent than the catalysts absent cobalt phyllosilicate (for example, used cobalt-based catalyst A).

### Example 13

This example proceeded the same as the heated experiments in Example 11 apart from hot ascorbic acid (18 wt. %) was additionally combined with hot glycolic acid (15 wt. %). The temperature of the hot ascorbic and glycolic acid was approximately 80-90° C.

| | | Wt. % Cobalt | |
|---|---|---|---|
| | Wt. % Cobalt | Extracted with | Wt. % Cobalt |
| | Extracted with | Hot Ascorbic | Extraction with |
| | Hot Ascorbic | Acid and | Hot Glycolic |
| Waste Material | Acid | Glycolic Acid | Acid |
| Fresh cobalt-based | 92 | 93 | 30 |
| catalyst A | | | |
| Used cobalt-based | 53 | 86 | 86 |
| catalyst F | | | |

Cobalt from the fresh catalyst was leached more effectively with hot ascorbic acid compared to hot glycolic acid.

Without wishing to be bound by theory, used cobalt-based catalyst F, which is believed to have a large fraction of cobalt silicate species, had a larger degree of cobalt extraction with the leaching composition comprising hot glycolic acid.

The leaching composition comprising both hot ascorbic acid and glycolic acid showed good cobalt extraction, with greater than 80% achieved, for both the fresh and used catalyst. This leaching composition therefore provides excellent cobalt extraction for a wider range of catalyst samples then the leaching composition consisting of the individual components alone.

1. A leaching composition for extracting cobalt from a waste material, wherein the composition comprises at least one chemically active organic lixiviant comprising at least one weakly acidic hydroxyl group, the organic lixiviant being effective to alter the oxidation state of cobalt in the waste material and generate a soluble cobalt(II) ionic species comprising an anion derived from the organic lixiviant, wherein the organic lixiviant comprises at least one carboxylic acid and a non-carboxylic acid.

2. The leaching composition according to claim 1, wherein the at least one organic lixiviant comprises at least one abstractable proton.

3. (canceled)

4. (canceled)

5. The leaching composition according to claim 1, wherein the at least one organic lixiviant comprises a hydrogen donor having the capacity to oxidize cobalt metal in situ and generate hydrogen gas.

6. (canceled)

7. (canceled)

8. (canceled)

9. The leaching composition according to claim 1, wherein the at least one organic lixiviant comprises a phenol or phenolic derivative or suitable combinations thereof.

10. The leaching composition according to claim 9, wherein the at least one carboxylic acid comprises a hydroxycarboxylic acid.

11. (canceled)

12. The leaching composition according to claim 9, wherein the non-carboxylic acid is ascorbic acid.

13. The leaching composition according to claim 9, wherein the leaching composition further comprises a phenolic derivative, optionally wherein the phenolic derivative is hydroquinone.

14. The leaching composition according to claim 1, wherein the at least one organic lixiviant is provided in combination with at least one compatible oxidising and/or reducing agent in the leaching composition, or one or more compatible adjuvant(s) or excipient(s).

15. The leaching composition according to claim 14, wherein at least one adjuvant or excipient is selected from EDTA or other polyfunctional amine, surfactants, PEGs, PPGs, alcohols, ethers, esters and anhydrides or suitable combinations of two or more thereof.

16. A process for extracting cobalt from a waste material, comprising the step of subjecting the waste material to chemical leaching in the presence of a leaching composition according to claim 1 to separate cobalt from the waste material.

17. The process according to claim 16, wherein the waste material is a spent catalyst.

18. (canceled)

19. The process according to claim 16, wherein the process is carried out in a reactor.

20. The process according to claim 19, wherein the reactor is a fixed bed reactor or a microchannel reactor.

21. The process according to claim 19, wherein the leaching composition is flowed through the reactor in fluid communication with the waste material.

22. The process according to claim 19, further comprising the preliminary step(s) of dewaxing, oxidising and/or reducing the waste material.

23. The process according to claim 19, further comprising the step of recovering the leached cobalt from the reactor.

24. The process according to claim 16, further comprising the step of discharging the cobalt-depleted waste material substrate from the reactor.

25. The process according to claim 24, wherein the cobalt-depleted catalyst substrate is discharged from the reactor:
using ultrasonic agitation;
using a stream of compressed air; and/or
using an external magnet.

26. (canceled)

27. The process according to claim 16, wherein the extracted cobalt is contacted with a cation exchange material for the purpose of isolating cobalt.

28. A process for selectively separating cobalt from a waste material in a reactor, wherein the waste material is a spent catalyst, comprising the steps of:
a) de-waxing the catalyst;
b) optionally oxidising the de-waxed catalyst;
c) subjecting the optionally oxidised catalyst to chemical leaching in the presence of a leaching composition according to claim 1 to separate the cobalt from the catalyst substrate; and
d) recovering the leached metal from the reactor.
